(19) United States
(12) Patent Application Publication
(10) Pub. No.: US 2025/0333120 A1
(43) Pub. Date: Oct. 30, 2025

(54) Utility Vehicle

(71) Applicant: Kubota Corporation, Osaka-shi (JP)

(72) Inventor: Hiroki Bessho, Osaka (JP)

(21) Appl. No.: 19/174,228

(22) Filed: Apr. 9, 2025

(30) Foreign Application Priority Data
Apr. 25, 2024 (JP) 2024-071474

(51) Int. Cl. B62D 33/08; B60N 2/20; B60N 2/36

(52) U.S. Cl. CPC B62D 33/08; B60N 2/206; B60N 2002/363

(57) ABSTRACT

A utility vehicle includes a body with an occupant part including a front occupant space for driving and a rear occupant space rearward of the front occupant space; a cargo bed rearward of the occupant part; and a cargo bed extender. The cargo bed extender is switchable between an extending orientation in which the cargo bed extender extends forward from the cargo bed and is in the rear occupant space, and a non-extending orientation in which the cargo bed extender is rearward of the rear occupant space and overlaps with a front portion of the cargo bed.

### CROSS-REFERENCE TO RELATED APPLICATION

This application claims priority to Japanese Patent Application No. 2024-071474 filed Apr. 25, 2024, the disclosure of which is hereby incorporated by reference in its entirety.

### BACKGROUND OF THE INVENTION

### Field of the Invention

The present invention relates to a utility vehicle with a cargo bed.

### Description of Related Art

There has been known a utility vehicle which includes a cargo bed (with a floor bed and side walls) and a cargo bed extender (with a bottom wall, side walls, and an extender tailgate) with which a capacity of the cargo bed can be increased as shown in, for example, U.S. Pat. No. 5,456,511.

In the above-mentioned cargo bed extension, the cargo bed is extended in such a manner that the cargo bed extender protrudes rearward from the cargo bed, and as a result, an overall length of the vehicle is increased as compared with the overall length of the vehicle before the cargo bed extension.

### SUMMARY OF THE INVENTION

The present invention provides a utility vehicle with a cargo bed which is extendable without increasing the overall length of the vehicle.

A utility vehicle of the present invention includes: a body with an occupant part including a front occupant space for driving and a rear occupant space rearward of the front occupant space; a cargo bed rearward of the occupant part; and a cargo bed extender, the cargo bed extender being switchable between an extending orientation in which the cargo bed extender extends forward from the cargo bed and in the rear occupant space, and a non-extending orientation in which the cargo bed extender is rearward of the rear occupant space and overlaps with a front portion of the cargo bed.

With the above configuration, a capacity of the cargo bed is increased by the cargo bed extender which extends forward from the cargo bed and in the rear occupant space. Since the rear occupant space is utilized as a space for the cargo bed extender in the extending orientation, the capacity of the cargo bed can be increased by the cargo bed extender without increasing the overall length of the vehicle.

In one aspect of the present invention, the cargo bed extender has a pivot axis extending in a width direction of the body, and the cargo bed extender is placed in the extending orientation by being swung downward about the pivot axis toward a front side of the body to become lying, and placed in the non-extending orientation by being swung upward about the pivot axis toward a rear side of the body to become standing.

For example, in a case of a vehicle having a cargo bed extender whose non-extending orientation is achieved by folding the cargo bed extender below the body, it is cumbersome to switch the orientation of the cargo bed extender between the extending orientation and the non-extending orientation. In addition, in such a case, the cargo bed extender in the non-extending orientation tends to become dirty. On the other hand, with the configuration above, the orientation of the cargo bed extender can be switched between the extending and non-extending orientations by simply swinging the cargo bed extender upward and downward, and thus switching of the orientation of the cargo bed extender becomes simple. In addition, the cargo bed extender in the non-extending orientation is standing and unlikely to become dirty. As a result, handling of the cargo bed extender is facilitated, and the space for loading cargo can be easily increased or reduced.

In one aspect of the present invention, the cargo bed includes: a bottom plate; side frame sections on respective lateral sides of the bottom plate; and a rear frame section in a rear portion of the bottom plate, the cargo bed having a front opening that opens towards a front side in the front portion of the cargo bed, the cargo bed extender includes: an extender bottom plate; extender side frame sections on respective lateral sides of the extender bottom plate; and an extender front frame section in a front portion of the extender bottom plate, and in the non-extending orientation, the extender bottom plate covers the front opening.

With the above configuration, when the cargo bed extender is in the non-extending orientation, the front opening of the cargo bed is covered by the extender bottom plate. As a result, in a case where the cargo bed extender is in the non-extending orientation and cargo is loaded on the cargo bed, the extender bottom plate can be utilized as a front frame for covering the front opening.

In one aspect of the present invention, in the non-extending orientation of the cargo bed extender, the extender side frame sections are laterally outward of the respective side frame sections.

In a case of a vehicle having a cargo bed extender whose extender side frame sections in the non-extending orientation are present inside the side frame sections of the cargo bed, the extender side frame sections tend to hinder the loading of cargo on the cargo bed. With the above configuration, since the extender side frame sections are outside the side frame sections of the cargo bed, the extender side frame sections do not hinder the loading of cargo on the cargo bed, and the loading is facilitated.

In one aspect of the present invention, the utility vehicle further includes a rear seat in the rear occupant space, the rear seat including a seat base and a seat back, wherein the seat back is attached to an outer side of the cargo bed extender, in the extending orientation of the cargo bed extender, the seat back is in a retracting state in which the seat back is lying on the seat base, and in the non-extending orientation of the cargo bed extender, the seat back is in a usable state in which the seat back is standing above the seat base.

When the orientation of the cargo bed extender is switched to the extending orientation, a state of the seat back is also switched to the retracting state by the cargo bed extender having entered the rear occupant space. Therefore, for utilizing the rear occupant space as a space for installing the cargo bed extender, there is no need to separately place the seat back into the retracting state. In addition, when the orientation of the cargo bed extender is switched to the extending orientation, a state of the seat back is also switched to the usable state by the cargo bed extender having moved out from the rear occupant space. Therefore, for making the rear seat usable, there is no need to separately return the seat back to the usable state. With the above configuration, the labor to switch the state of the seat back is unnecessary, and thus the switching of the cargo bed extender between the extending orientation and the non-extending orientation is facilitated.

### BRIEF DESCRIPTION OF THE DRAWINGS

FIG. 1 is a left side view of a utility vehicle with a cargo bed extender in a non-extending orientation.

FIG. 2 is a plan view of the utility vehicle with the cargo bed extender in the non-extending orientation.

FIG. 3 is a rear view of the cargo bed extender in the non-extending orientation.

FIG. 4 is a left side view of the utility vehicle with the cargo bed extender in an extending orientation.

FIG. 5 is a plan view of the utility vehicle with the cargo bed extender in the extending orientation.

### DESCRIPTION OF THE INVENTION

An embodiment of the present invention will be described below with reference to the drawings.

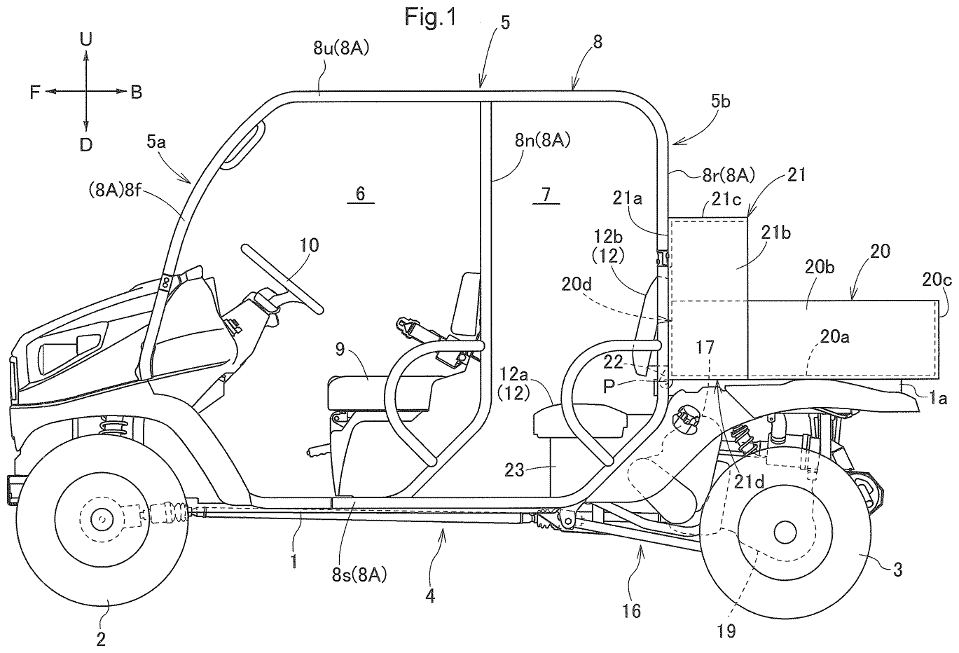

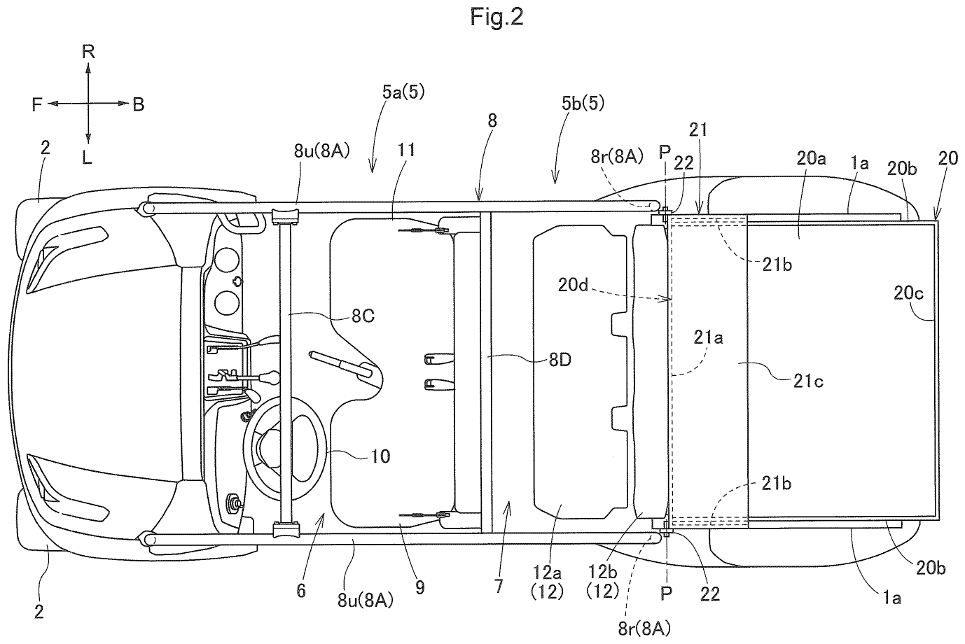

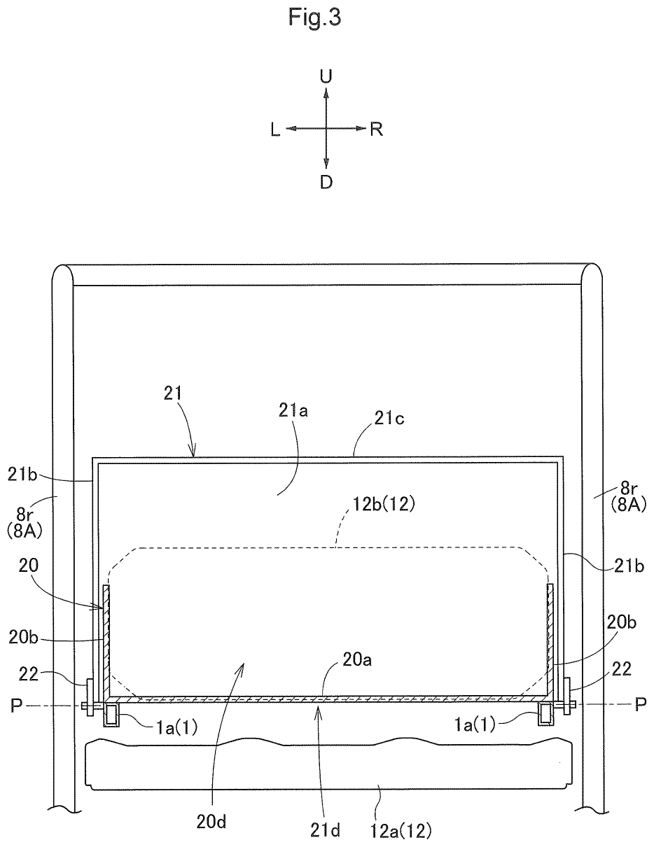

In the following description, with respect to a body of the utility vehicle, a side indicated by an arrow F in FIGS. 1 and 2 is a “front” side of the body, a side indicated by an arrow B in FIGS. 1 and 2 is a “rear” side of the body, a side indicated by an arrow U in FIGS. 1 and 3 is an “upper” side of the body, a side indicated by an arrow D in FIGS. 1 and 3 is a “lower” side of the body, a side indicated by an arrow L in FIGS. 2 and 3 is a “left” side of the body, and a side indicated by an arrow R in FIGS. 2 and 3 is a “right” side of the body. A right-left direction of the body corresponds to a transversal direction of the body, and may also be referred to as a “width” direction or a “lateral” direction of the body. A front-rear direction of the body corresponds to a longitudinal direction of the body.

### Entire Structure of Utility Vehicle

A utility vehicle shown in FIGS. 1, 2, 4 and 5 is used for various purposes, such as load carriage and recreation. The utility vehicle includes: a body 4 with a body frame 1; a pair of steerable (turnable) and drivable front wheels 2 (one right and one left) forward of the body frame 1; and a pair of drivable rear wheels 3 (one right and one left) rearward of the body frame 1. An occupant part 5 is between the front wheels 2 and the rear wheels 3 of the body 4. The occupant part 5 includes: a front occupant section 5a; a rear occupant section 5b rearward of the front occupant section 5a; and a roll-over protection system (ROPS) 8 surrounding a front occupant space 6 of the front occupant section 5a and a rear occupant space 7 of the rear occupant section 5b. The front occupant section 5a is a section for driving. The front occupant section 5a includes: a driver's seat 9; a steering wheel 10 for steering the front wheels 2; and a front occupant seat 11 which is different from the driver's seat 9. The driver's seat 9 and the front occupant seat 11 are contiguous. The rear occupant section 5b includes a single seat as a rear seat 12 whose overall width is roughly close to a width of the rear occupant space 7. In a rear part of the body 4, a cargo bed 20 is disposed. Below the cargo bed 20, a motive section 16 is disposed. The motive section 16 includes: an engine 17; and a transmission 19 with a gear transmission section (not shown) which is configured to change a motive power from the engine 17 and output the changed motive power to the front wheels 2 and the rear wheels 3.

As shown in FIGS. 1, 2 and the like, the ROPS 8 includes: side frames 8A on respective lateral sides of the occupant part 5; a first intermediate connection frame 8C connecting respective intermediate portions in a front-rear direction of the two side frames 8A; and a second intermediate connection frame 8D connecting respective intermediate portions in the front-rear direction of the two side frames 8A, the second intermediate connection frame 8D being rearward of the first intermediate connection frame 8C. Each of the side frames 8A includes: an upper front-rear frame section 8u; a lower front-rear frame section 8s; a front pillar frame section 8f connecting the upper front-rear frame section 8u and the lower front-rear frame section 8s at their respective front portions; an intermediate pillar frame section 8n connecting the upper front-rear frame section 8u and the lower front-rear frame section 8s at their respective intermediate portions in the front-rear direction; and a rear pillar frame section 8r connecting the upper front-rear frame section 8u and the lower front-rear frame section 8s at their respective rear portions.

### Cargo Bed and Cargo Bed Extender

As show in FIGS. 1 and 2, in addition to the cargo bed 20, a cargo bed extender 21 is disposed in the rear part of the body 4. The cargo bed 20 is extendable with use of the cargo bed extender 21.

Specifically, as shown in FIGS. 1 and 2, the cargo bed 20 is rearward of the occupant part 5. The cargo bed 20 has a bottom portion whose lower side is supported by the body frame 1, through a connection with right and left cargo bed support frame portions 1a of the body frame 1.

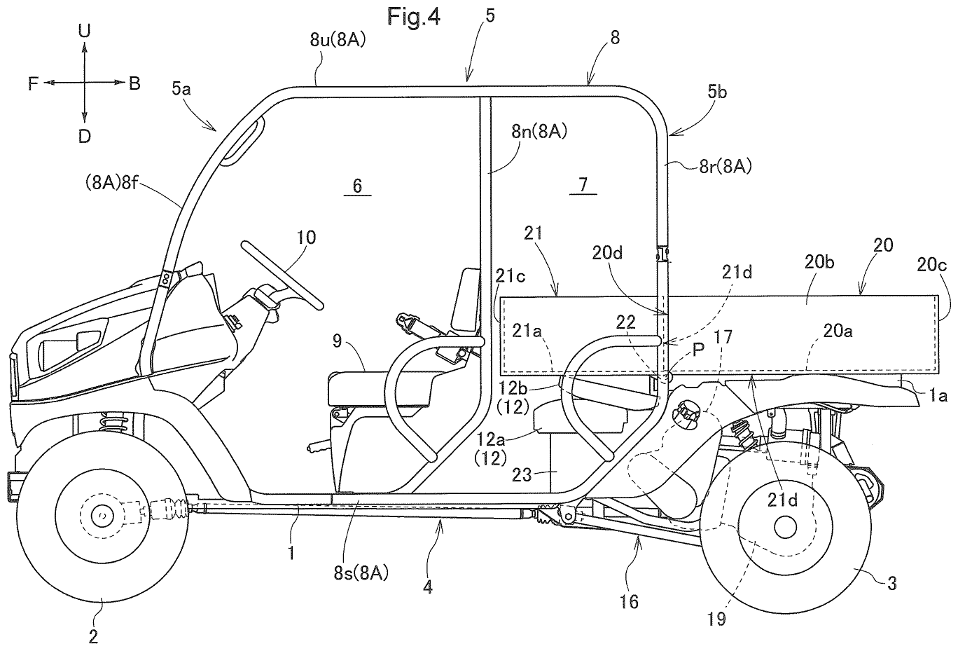

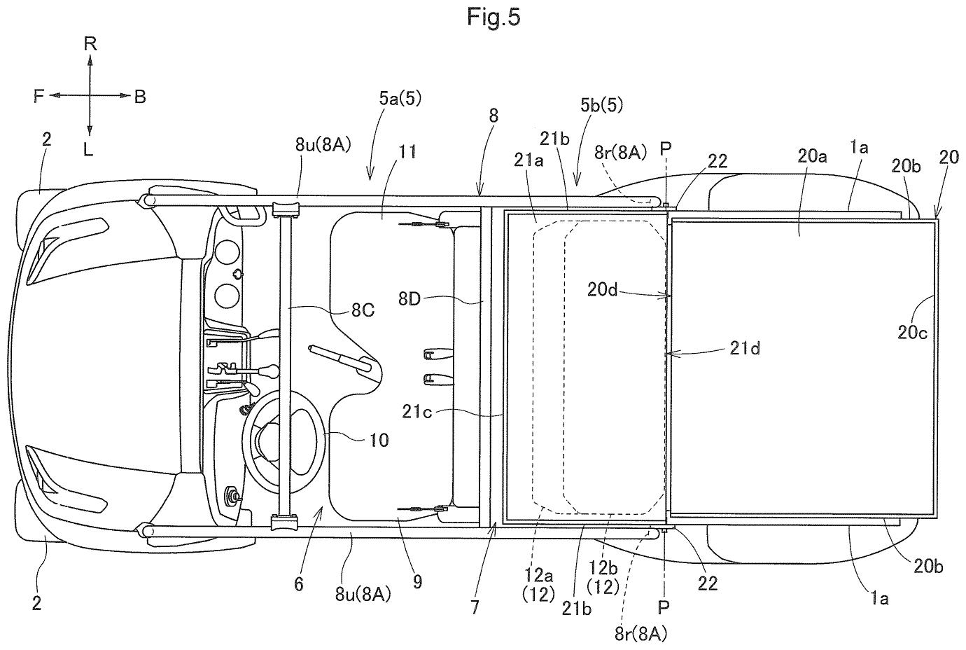

A rear portion of the cargo bed extender 21 in an extending orientation (see FIGS. 4 and 5) is provided with joints 22. The joints 22 are on the respective lateral sides (one right and one left) below the cargo bed extender 21. The right and left joints 22 are swingably supported by the right and left cargo bed support frame portions 1a, respectively. The cargo bed extender 21 is supported by the body frame 1 in such a manner that the cargo bed extender 21 is operated to be swung about a pivot axis P extending in a width direction of the body between the right and left joints 22. The orientation of the cargo bed extender 21 is switchable between the extending orientation (see FIGS. 4 and 5) and a non-extending orientation (see FIGS. 1 and 2), by a swing operation about the pivot axis P.

As shown in FIGS. 1 and 2, the cargo bed 20 includes: a bottom plate 20a; side frame sections 20b standing from the bottom plate 20a on respective lateral sides of the bottom plate 20a; and a rear frame section 20c standing from the bottom plate 20a in a rear portion of the bottom plate 20a. A front portion of the cargo bed 20 has a front opening 20d that opens towards a front side. The front opening 20d is defined by a front portion of the bottom plate 20a and respective front portions of the right and left side frame sections 20b, and is disposed above the bottom plate 20a and between the right and left side frame sections 20b.

As shown in FIGS. 4 and 5, the cargo bed extender 21 in the extending orientation includes: an extender bottom plate 21a; extender side frame sections 21b standing from the extender bottom plate 21a from respective side portions of the extender bottom plate 21a; and an extender front frame section 21c standing from the extender bottom plate 21a from a front portion of the extender bottom plate 21a. The rear portion of the cargo bed extender 21 has a rear opening 21d that opens towards a rear side. The rear opening 21d is defined by a rear portion of the extender bottom plate 21a and respective rear portions of the right and left extender side frame sections 21b, and is above the extender bottom plate 21a and between the right and left extender side frame sections 21b.

As shown in FIG. 1, the rear seat 12 in the rear occupant section 5b includes a seat base 12a and a seat back 12b. The seat base 12a is supported by a seat support 23 in the rear occupant section 5b. The seat back 12b is disposed separately from the seat base 12a and attached to an outer side of the extender bottom plate 21a of the cargo bed extender 21.

When the cargo bed extender 21 is swung downward about the pivot axis P toward the front side, the cargo bed extender 21 passes between the right and left rear pillar frame sections 8r of the ROPS 8 and enters the rear occupant space 7 and then lies (see FIGS. 4 and 5). At the same time, the seat back 12b attached to the extender bottom plate 21a is also swung downward toward the front side with the cargo bed extender 21 and placed in a retracting state in which the seat back 12b is lying on the seat base 12a. As a result, the cargo bed extender 21 is received and supported by the seat base 12a through the seat back 12b and the orientation of the cargo bed extender 21 is fixed, i.e., placed in the extending orientation in which the cargo bed extender 21 extends forward from the cargo bed 20 into the rear occupant space 7. With the cargo bed extender 21 being in the extending orientation, the cargo bed 20 is extended forward by the cargo bed extender 21.

Specifically, when the cargo bed extender 21 is in the extending orientation, the rear opening 21d of the cargo bed extender 21 and the front opening 20d of the cargo bed 20 face each other, and the bottom plate 20a of the cargo bed 20 is extended forward by the extender bottom plate 21a of the cargo bed extender 21, and the right and left side frame sections 20b of the cargo bed 20 are respectively extended forward by the right and left extender side frame sections 21b of the cargo bed extender 21. As a result, cargo can be loaded on both the cargo bed 20 and the cargo bed extender 21. In other words, a space for loading cargo in the utility vehicle is expanded from a space for loading cargo of the cargo bed 20 to a combined space of the cargo bed 20 and the cargo bed extender 21.

When the cargo bed extender 21 is swung upward about the pivot axis P toward the rear side, the cargo bed extender 21 passes between the right and left rear pillar frame sections 8r of the ROPS 8 and moves out from the rear occupant space 7 and stands upright (see FIGS. 1 and 2). As a result, the cargo bed extender 21 is placed in the non-extending orientation in which a part of the cargo bed extender 21 overlaps with the front portion of the cargo bed 20. When the cargo bed extender 21 is placed in the non-extending orientation, the extension of the cargo bed 20 with the cargo bed extender 21 is cancelled.

Specifically, when the cargo bed extender 21 is in the non-extending orientation, the extension of the bottom plate 20a of the cargo bed 20 by the extender bottom plate 21a is cancelled, and the extension of the right and left side frame sections 20b of the cargo bed 20 by the respective extender side frame sections 21b is cancelled. As a result, while cargo can be loaded on the cargo bed 20, cargo can no longer be loaded on the cargo bed extender 21. In other words, the space for loading cargo in the utility vehicle is reduced only to the space of the cargo bed 20.

As shown in FIG. 1, when the orientation of the cargo bed extender 21 is switched to the non-extending orientation, the seat back 12b of the rear seat 12 is raised from the seat base 12a by the cargo bed extender 21, and the seat back 12b is returned from a state in which the seat back 12b is on the seat base 12a to a usable state in which the seat back 12b is in a predetermined orientation at a position above and rearward of the seat base 12a. Once the orientation of the cargo bed extender 21 is switched to the non-extending orientation, the cargo bed extender 21 is moved out from the rear occupant space 7 and a passenger can board the rear occupant section 5b, and the seat back 12b is returned to the usable state and the rear seat 12 becomes usable.

With reference to FIGS. 1 to 3, when the cargo bed extender 21 is in the non-extending orientation, the extender bottom plate 21a of the cargo bed extender 21 standing upright is forward of the cargo bed 20, and the front opening 20d of the cargo bed 20 is covered with the extender bottom plate 21a from the front side. In a case where the cargo bed extender 21 is in the non-extending orientation and cargo is loaded on the cargo bed 20, the extender bottom plate 21a is utilized as a front frame for covering the front opening 20d.

As shown in FIG. 3, when the cargo bed extender 21 is in the non-extending orientation, the right and left extender side frame sections 21b of the cargo bed extender 21 are laterally outward of the respective side frame sections 20b of the cargo bed 20. In a case where the cargo bed extender 21 is in the non-extending orientation and cargo is loaded on the cargo bed 20, the extender side frame sections 21b does not hinder the loading of the cargo.

### Other Embodiments

(1) In the embodiment above, the orientation of the cargo bed extender 21 is switched between the extending orientation and the non-extending orientation by swinging. However, the present invention is not limited to this embodiment. The cargo bed extender may be held by the cargo bed support frame portion la and the cargo bed 20 in such a manner that the cargo bed extender is slidable in the front-rear direction to thereby switch the orientation between the extending orientation and the non-extending orientation.

(2) In the embodiment above, when the cargo bed extender 21 is in the non-extending orientation, the extender bottom plate 21a covers the front opening 20d of the cargo bed 20, and the extender side frame sections 21b are laterally outward of the side frame sections 20b of the cargo bed 20. However, the present invention is not limited to this embodiment. The extender bottom plate 21a may not cover the front opening 20d. The extender side frame sections 21b may be laterally inward of the respective side frame sections 20b.

(3) In the embodiment above, the seat back 12b is attached to the cargo bed extender 21. However, the present invention is not limited to this embodiment. The seat back 12b may not be attached to the cargo bed extender 21 and may be provided separately from the cargo bed extender 21. The orientation of the seat back 12b may be switchable between a lying orientation in which the cargo bed extender 21 is in the rear occupant space 7 and a standing orientation in which the rear seat 12 is usable, by an operation separate from the operation to switch the orientation of the cargo bed extender 21.

(4) In the embodiment above, the orientation of the cargo bed extender 21 is switched by a manual operation. However, it may be changed by an actuator, such as cylinder and motor.

### INDUSTRIAL APPLICABILITY

The present invention is applicable to a utility vehicle with a cargo bed.
REFERENCE SIGNS LIST
5 occupant part
6 front occupant space
7 rear occupant space
12 rear seat
12a seat base
12b seat back
20 cargo bed
20a bottom plate
20b side frame section
20c rear frame section
20d front opening
21 cargo bed extender
21a extender bottom plate
21b extender side frame section
21c extender front frame section
P pivot axis

1. A utility vehicle comprising:
a body with an occupant part comprising a front occupant space for driving and a rear occupant space rearward of the front occupant space;
a cargo bed rearward of the occupant part; and
a cargo bed extender, and
wherein the cargo bed extender is switchable between:
an extending orientation in which the cargo bed extender extends forward from the cargo bed and in the rear occupant space, and
a non-extending orientation in which the cargo bed extender is rearward of the rear occupant space and overlaps with a front portion of the cargo bed.

2. The utility vehicle according to claim 1,
wherein the cargo bed extender has a pivot axis extending in a width direction of the body, and
wherein the cargo bed extender is placed in the extending orientation by being swung downward about the pivot axis toward a front side of the body to become lying, and placed in the non-extending orientation by being swung upward about the pivot axis toward a rear side of the body to become standing.

3. The utility vehicle according to claim 2, wherein:
the cargo bed comprises:
a bottom plate;
side frame sections on respective lateral sides of the bottom plate; and
a rear frame section in a rear portion of the bottom plate, the cargo bed having a front opening that opens towards a front side in the front portion of the cargo bed,
the cargo bed extender comprises:
an extender bottom plate;
extender side frame sections on respective lateral sides of the extender bottom plate; and
an extender front frame section in a front portion of the extender bottom plate, and
in the non-extending orientation of the cargo bed extender, the extender bottom plate covers the front opening.

4. The utility vehicle according to claim 3, wherein in the non-extending orientation of the cargo bed extender, the extender side frame sections are laterally outward of the respective side frame sections.

5. The utility vehicle according to claim 2, further comprising a rear seat in the rear occupant space, the rear seat comprising a seat base and a seat back,
wherein the seat back is attached to an outer side of the cargo bed extender,
wherein in the extending orientation of the cargo bed extender, the seat back is in a retracting state in which the seat back is lying on the seat base, and
wherein in the non-extending orientation of the cargo bed extender, the seat back is in a usable state in which the seat back is standing above the seat base.
